(19) United States
(12) Patent Application Publication
(10) Pub. No.: US 2025/0280056 A1
(43) Pub. Date: Sep. 4, 2025

(54) Systems and Methods for Creating a Multi-Protectorate Architecture in a Multi-Instance Cloud Infrastructure

(71) Applicant: Serenity EHS Inc., San Diego, CA (US)

(72) Inventors: Peter Bennett Oneppo, Menlo Park, CA (US); Juan Antonio Villagomez, San Diego, CA (US)

(73) Assignee: Serenity EHS Inc., San Diego, CA (US)

(21) Appl. No.: 19/067,652

(22) Filed: Feb. 28, 2025

Related U.S. Application Data
(60) Provisional application No. 63/559,723, filed on Feb. 29, 2024.

(51) Int. Cl. H04L 67/306; H04L 67/148

(52) U.S. Cl. CPC H04L 67/306; H04L 67/148

(57) ABSTRACT

Systems and methods for provisioning users in a multi-protectorate architecture in accordance with embodiments of the invention are illustrated. One embodiment includes a method for provisioning users in a multi-protectorate architecture on an instanced architecture. The method includes steps for creating a user in a first domain, receiving a request for available domains, wherein each domain is associated with a protectorate of the multi-protectorate architecture, making an elevated request based on the received request for available domains, returning requested available domains as a response to the received request for available domains, and moving created user from the first domain to a second domain.

### CROSS-REFERENCE TO RELATED APPLICATIONS

The current application claims the benefit of and priority under 35 U.S.C. § 119(e) to U.S. Provisional Patent Application No. 63/559,723 entitled “Systems and Methods for Creating a Multi-Protectorate Architecture in a Multi-Instance Cloud Infrastructure” filed Feb. 29, 2024. The disclosure of U.S. Provisional Patent Application No. 63/559,723 is hereby incorporated by reference in its entirety for all purposes.

### FIELD OF THE INVENTION

The present invention generally relates to providing cloud services and, more specifically, creating multi-protectorate architectures in multi-instance cloud infrastructures.

### BACKGROUND

Multi-tenant architectures involve a single instance of a software application serving multiple clients or tenants, sharing resources like servers and databases while maintaining isolation to ensure data privacy and security. It offers cost-efficiency, scalability, and some customization options. In contrast, multi-instance architectures provide separate instances for each tenant, offering stronger isolation, more extensive customization, and dedicated resources per instance. However, it may entail higher management complexity compared to multi-tenancy. Many existing cloud systems implement either multi-tenant or multi-instance architectures.

### SUMMARY OF THE INVENTION

Systems and methods for provisioning users in a multi-protectorate architecture in accordance with embodiments of the invention are illustrated. One embodiment includes a method for provisioning users in a multi-protectorate architecture on an instanced architecture. The method includes steps for creating a user in a first domain, receiving a request for available domains, wherein each domain is associated with a protectorate of the multi-protectorate architecture, making an elevated request based on the received request for available domains, returning requested available domains as a response to the received request for available domains, and moving created user from the first domain to a second domain.

In a further embodiment, the request is received from the first user in the first domain.

In still another embodiment, making an elevated request includes making a call to an API endpoint for a global domain, wherein the global domain has access to a plurality of domains and the first domain does not have access to the plurality of domains.

In a still further embodiment, each of a plurality of domains is associated with a company, the created user is associated with a company, and the requested available domains include at least one domain associated with the company.

In yet another embodiment, the created user is automatically moved from the first domain to the domain associated with the company.

In a yet further embodiment, each of a plurality of domains is associated with a set of existing users, the created user is associated with at least one user of the set of existing users, and at least one of the requested available domains is identified based on the at least one associated user.

In another additional embodiment, the second domain is one of the returned available domains.

Systems and methods for creating a multi-protectorate architecture in accordance with embodiments of the invention are illustrated. One embodiment includes a method for creating multi-protectorate architectures on an instanced architecture. The method includes steps for receiving a request to provision a new protectorate, communicating with an instanced architecture to create the new protectorate, monitoring information about a plurality of protectorates operating on a set of one or more instances of the instanced architecture, and moving a protectorate from a first instance to a second instance based on the monitored information.

In a further additional embodiment, the request to provision a new protectorate is from a user, the method further comprising generating a user record for the user, and generating an onboarding record for the new protectorate.

In another embodiment again, the user record is created in an onboarding domain and creating the new protectorate comprises creating a new domain, creating a set of records in the new domain, and moving the user record for the user from the onboarding domain to the new domain.

In a further embodiment again, the method further includes steps for updating the onboarding record when the domain is created.

In still yet another embodiment, monitoring information includes monitoring at least one selected from the group consisting of revenue, daily average users (DAU), number of transactions, and number of employees.

In a still yet further embodiment, moving the protectorate comprises providing a pool of record numbers from a primary protectorate, and using the pool of record numbers to create new records for the protectorate.

In still another additional embodiment, moving a protectorate includes providing a prefix unique to each instance of a multi-instance architecture to each of a plurality of protectorates, wherein each protectorate of the plurality of protectorates utilizes the prefix for data within the protectorate.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a multi-protectorate system in accordance with an embodiment of the invention.

FIG. 2 illustrates an example of a lifecycle of a protectorate in a multi-protectorate architecture in accordance with an embodiment of the invention.

FIGS. 3A-3B illustrate an example of an account creation process in accordance with an embodiment of the invention.

FIG. 4 illustrates an example of a user profile creation UI in accordance with an embodiment of the invention.

FIG. 5 illustrates an example of a user interface (UI) for associating a user with a protectorate in accordance with an embodiment of the invention.

FIG. 6 illustrates an example of a UI for collecting information for a new protectorate in accordance with an embodiment of the invention.

FIG. 7 illustrates an example of a completion screen in accordance with an embodiment of the invention.

FIGS. 8A-8B illustrate an example of a UI for joining an existing protectorate in accordance with an embodiment of the invention.

FIG. 9 conceptually illustrates an example of a process for provisioning in accordance with an embodiment of the invention.

FIG. 10 illustrates an example of a workspace in accordance with an embodiment of the invention.

FIG. 11 illustrates an example of load balancing in accordance with an embodiment of the invention.

FIG. 12 illustrates an example of a multi-protectorate system that creates multi-protectorate architectures in accordance with an embodiment of the invention.

FIG. 13 illustrates an example of a multi-protectorate element that executes instructions to perform processes that create multi-protectorate architectures in accordance with an embodiment of the invention.

### DETAILED DESCRIPTION

Turning now to the drawings, systems and methods in accordance with numerous embodiments of the invention enable multi-protectorate architectures in multi-instance cloud infrastructures. Protectorates in accordance with many embodiments of the invention can refer to a combination of various elements, such as (but not limited to) domains, management functions, data, business rules, applications, user roles, and/or groups, which can be provided for multiple separate organizations operating on a set of one or more instances of a multi-instance architecture. Multi-protectorate systems in accordance with a variety of embodiments of the invention can provide for data separation using domains, which maintain boundaries between protectorates. In many embodiments, multiple different tenants (or companies) may each operate independently and securely within a protectorate of a multi-protectorate system.

Domains in accordance with several embodiments of the invention can provide logical separations for different applications, data, users, etc. for each protectorate operating within a given instance. In a number of embodiments, multi-protectorate systems include a global domain, or a top-level domain that has visibility into all protectorates and/or their domains. Multi-protectorate systems in accordance with several embodiments of the invention include an onboarding domain for self-registration. Onboarding domains in accordance with numerous embodiments of the invention lack access to data from any other protectorates.

Many existing cloud systems implement multi-instance architectures to provide separate instances for each tenant. However, multi-instance architectures often require significant overhead and administration, making them impractical for smaller clients. In order to provide benefits from multi-instance architectures to smaller clients, systems and methods in accordance with various embodiments of the invention create a multi-protectorate architecture over an instanced (single-instance or multi-instance) cloud infrastructure. In a number of embodiments, multi-protectorate systems can provide for self-registration for new protectorates within a system, avoiding and/or automating much of the overhead otherwise associated with creating a new instance. Multi-protectorate systems in accordance with several embodiments of the invention can allow for self-entitlement (e.g., for applications) within an instance.

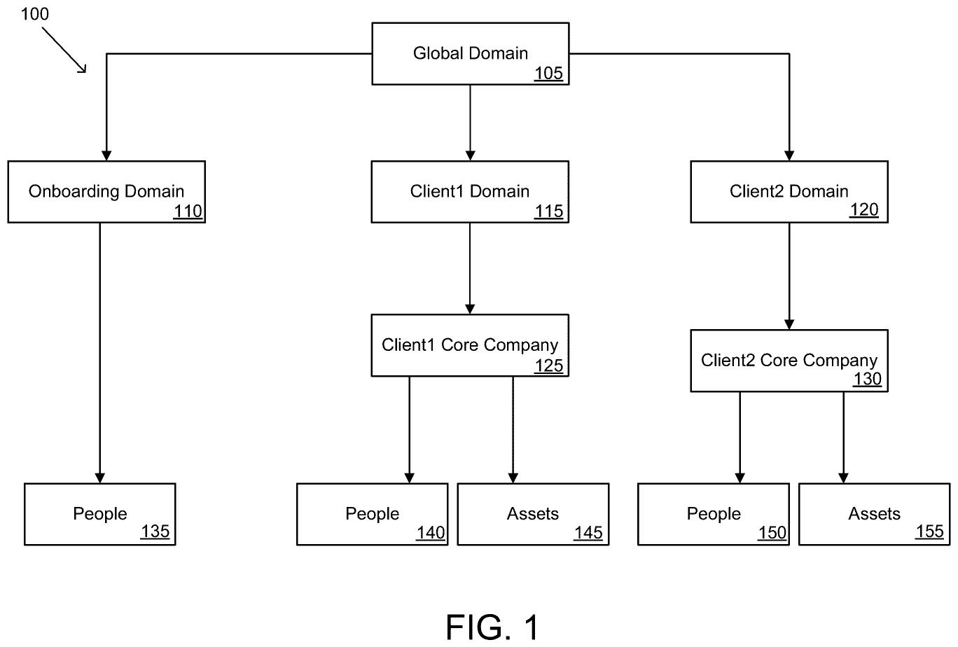

An example of a multi-protectorate system in accordance with an embodiment of the invention is illustrated in FIG. 1. Multi-protectorate system 100 includes a global domain 105, and sub-domains 110-120. Sub-domains 110-120 in this example include an onboarding domain 110, and client domains 115-120. Onboarding domain 110 includes a people data store 135. Client domains 115 and 120 include core company data stores 125 and 130 respectively. Along with the company data stores, each client domain 115 and 120 includes a people data store 140 and 150 and an assets store 145 and 155.

Global domains in accordance with some embodiments of the invention are higher-level domains that have access to each of the sub-domains of a multi-protectorate system. In some embodiments, global domains can execute system level processes with elevated permissions.

Sub-domains in accordance with several embodiments of the invention may include one or more onboarding domains, as well as client domains. Onboarding domains in accordance with various embodiments of the invention are limited access domains where new users, which aren't yet associated with one of the client domains, can be created and can operate without being provided access to potentially sensitive information. In a number of embodiments, onboarding domains have limited access to resources, such as (but not limited to) applications, databases, etc. In the example of FIG. 1, onboarding domain 110 includes a people data store 135, but no asset store.

In numerous embodiments, client domains include domains that are part of a protectorate. Client domains in accordance with certain embodiments of the invention provide data segregation, allowing users within a client domain to operate as though they were their own instance. In many embodiments, client domains include data stores for information associated with the protectorate, such as (but not limited to) core company data stores, people data stores, and asset data stores.

Core company data stores in accordance with a variety of embodiments of the invention store information about a given company. Company information in accordance with certain embodiments of the invention can include (but is not limited to) company name, address, self-registration preferences, application settings, security settings, etc.

People data stores in accordance with several embodiments of the invention store information about users and/or other entities (e.g., clients, vendors, etc.) associated with a domain. Information in accordance with several embodiments of the invention can include (but is not limited to) names, usernames, addresses, security information, titles, resource access levels, etc. In various embodiments, people data stores for an onboarding domain include users that have not yet been associated with a protectorate (and/or domain).

Asset data stores in accordance with several embodiments of the invention store information about assets associated with a company. In various embodiments, asset data stores include information about assets associated with a domain, such as (but not limited to), application licenses, databases, and/or other company assets.

As can readily be appreciated, the example in this figure illustrates a single example, but the specific elements and organizations of multi-protectorate systems is largely dependent upon the requirements of a given application and should not be considered as limited to any specific architecture or implementation.

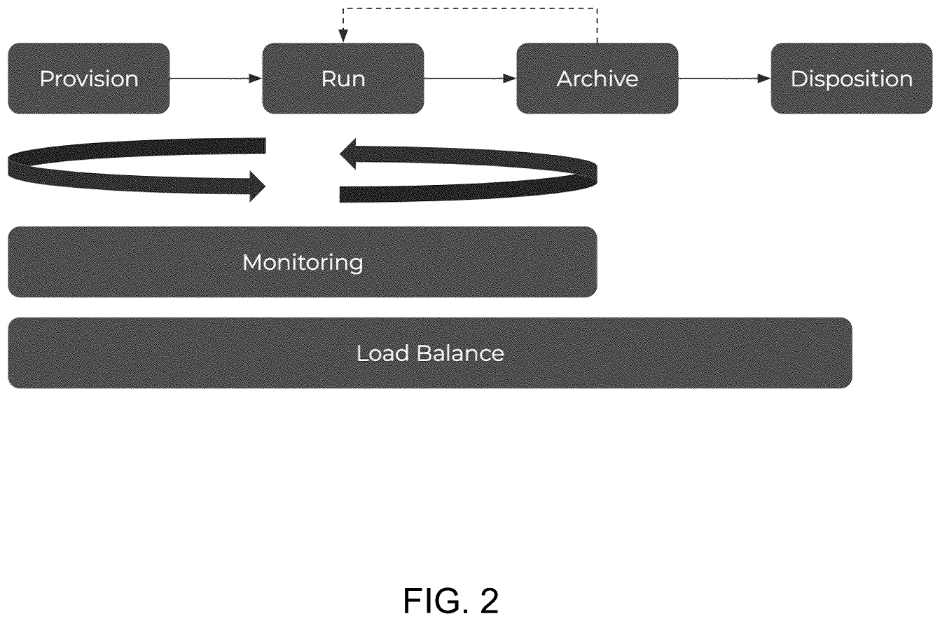

An example of a lifecycle of a protectorate in a multi-protectorate architecture in accordance with an embodiment of the invention is illustrated in FIG. 2. In this example, a protectorate is provisioned before it is run. Provisioning in accordance with a number of embodiments of the invention can include determining whether a new protectorate should be created (e.g., whether a protectorate for a user already exists, whether a user meets minimum requirements to create a protectorate, etc.). In many embodiments, multi-protectorate systems can communicate (e.g., via Application Programming Interfaces (APIs)) with an underlying instanced architecture to create various elements (e.g., domain, users, etc.) of a new protectorate. As the protectorate runs, monitoring and/or load balancing may be performed. In a number of embodiments, a primary protectorate may be selected to monitor other instances, perform load balancing, and/or manage data uniqueness across instances. Protectorates may be archived, restored from archives, and/or disposed. These processes are described in greater detail below.

While specific processes for creating multi-protectorate architectures are described above and throughout this description, any of a variety of processes can be utilized to create multi-protectorate architectures as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

### A. Provisioning

### 1. User Interface

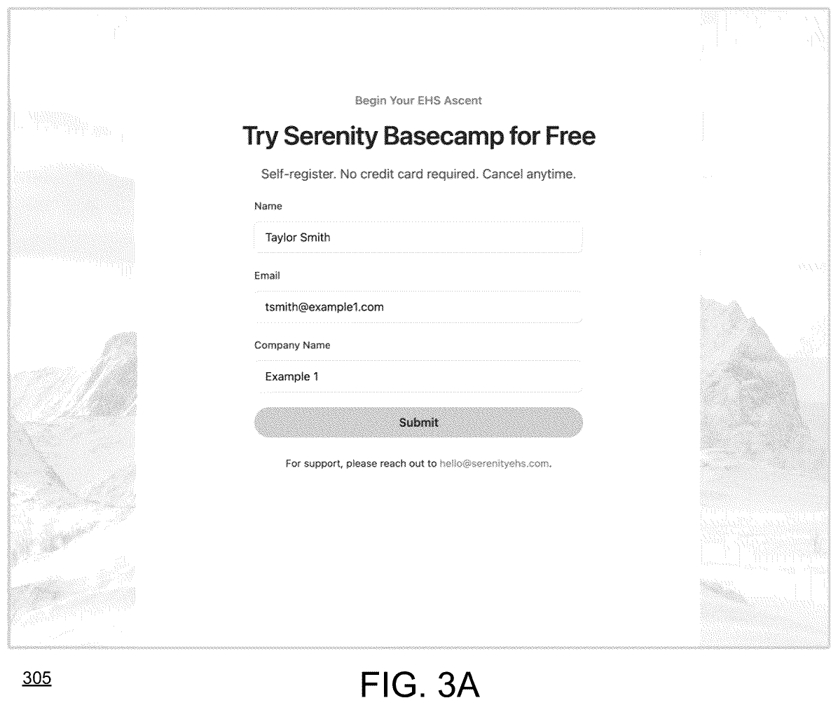

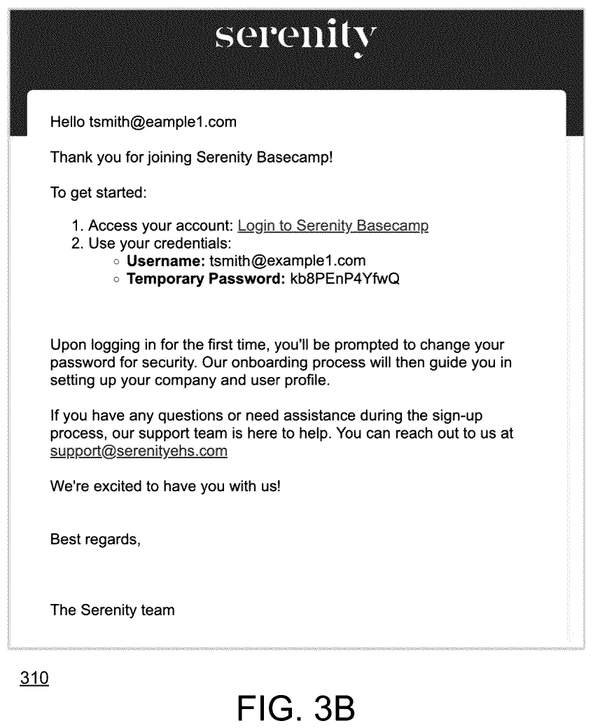

Provisioning of new protectorates in a multi-protectorate system in accordance with some embodiments of the invention creates protectorates across one or more instances of an instanced architecture. Examples of a provisioning process in accordance with an embodiment of the invention are illustrated in FIGS. 3-8. Provisioning in accordance with several embodiments of the invention can provide for a user to self-register within a platform. In a number of embodiments, provisioning can include automatically creating a protectorate with an initial set of records and/or settings.

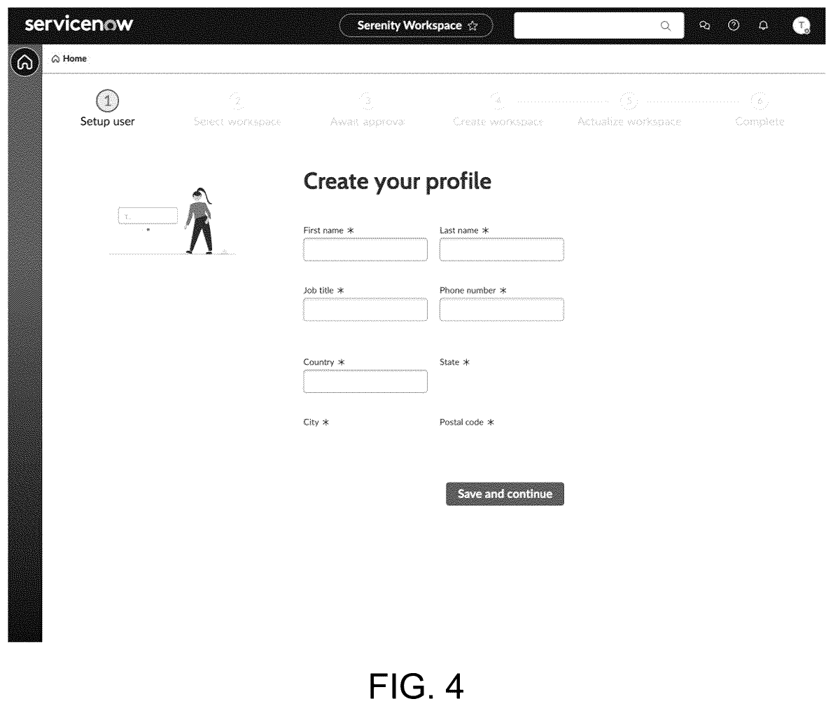

An example of an account creation process in accordance with an embodiment of the invention is illustrated in FIGS. 3-4. An example of an account creation process in accordance with an embodiment of the invention is illustrated in FIGS. 3A-3B. FIG. 3A illustrates a user interface (UI) presented to users to collect information, allow users to self-register, and create/join a protectorate. User interfaces in accordance with some embodiments of the invention can be presented on various elements in a multi-protectorate architecture, such as (but not limited to) mobile devices, personal computers, servers, etc. In this example, the UI 305 asks for a name, email, and company name. In various embodiments, initial self-registration processes may be performed from a system (e.g., a website) separate from the multi-protectorate system. In a number of embodiments, self-registration processes may be performed through an application directly hosted on a multi-protectorate system.

Once the initial information is provided, multi-protectorate systems in accordance with many embodiments of the invention may create records for the provisioning process. Records in accordance with a variety of embodiments of the invention may include user records and/or onboarding records. User records in accordance with various embodiments of the invention may be used for authenticating a user within a multi-protectorate system. Onboarding records in accordance with some embodiments of the invention track progress through an onboarding process.

In a variety of embodiments, progress can be tracked to create elements of a protectorate (e.g., records, domains, data structures, etc.) as they are needed. For example, onboarding records in accordance with several embodiments of the invention can allow a user to pick up where they left off if they leave the site and come back. For example, in several embodiments, domain records may not be created until a user gets far enough into the process. Onboarding records in accordance with some embodiments of the invention may track various progressions through an onboarding process, including (but not limited to) user account creation, company creation, domain creation, etc.

In some embodiments, multiple users may be associated with a single protectorate. During the provisioning phase, multiple user records may be associated with a single onboarding record, allowing for shared progress through the provisioning process. In a number of embodiments, onboarding records may be created in a separate onboarding domain, which does not have access to any other domains.

In a number of embodiments, once provisioning records have been created, users may proceed with a provisioning process. In the example of FIG. 3B, an email 310 is sent to the user's email with login information (e.g., username and password) and a link to continue the provisioning process.

In various embodiments, provisioning processes can include creating user profiles and associating users with protectorates. An example of a user profile creation UI in accordance with an embodiment of the invention is illustrated in FIG. 4. In this example, a user logs in and updates information in their profile. Profile information in accordance with many embodiments of the invention can include (but is not limited to) passwords, names, job titles, phone numbers, email addresses, location, etc.

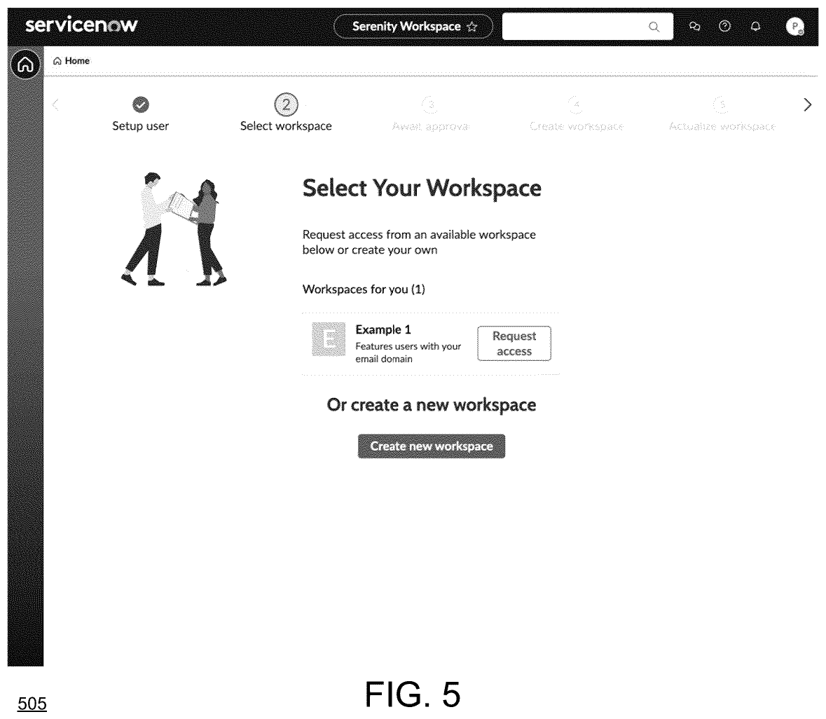

Multi-protectorate systems in accordance with various embodiments of the invention may also associate users with protectorates. In many embodiments, users may be associated with dynamically created protectorates and/or associated with existing protectorates. An example of workspace creation and provisioning in accordance with an embodiment of the invention is illustrated in FIGS. 5-9.

An example of a user interface (UI) for associating a user with a protectorate in accordance with an embodiment of the invention is illustrated in FIG. 5. In this example, UI 505 includes options to either create a new protectorate (or workspace) or to join an existing protectorate. In various embodiments, multi-protectorate systems may suggest a protectorate to associate with the user (e.g., based on an email address, geographic location, etc.).

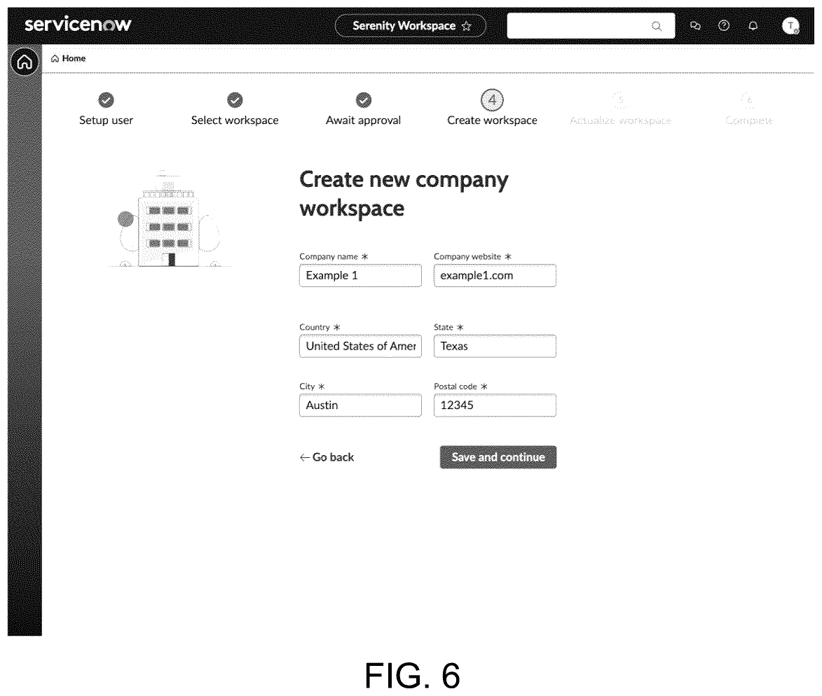

When a user chooses to create a new protectorate, multi-protectorate systems in accordance with several embodiments of the invention may collect information for the new protectorate and automatically create a new protectorate based on the information. An example of a UI for collecting information for a new protectorate in accordance with an embodiment of the invention is illustrated in FIG. 6. Protectorate information in accordance with numerous embodiments of the invention can include (but is not limited to) names, websites, geographic locations, etc.

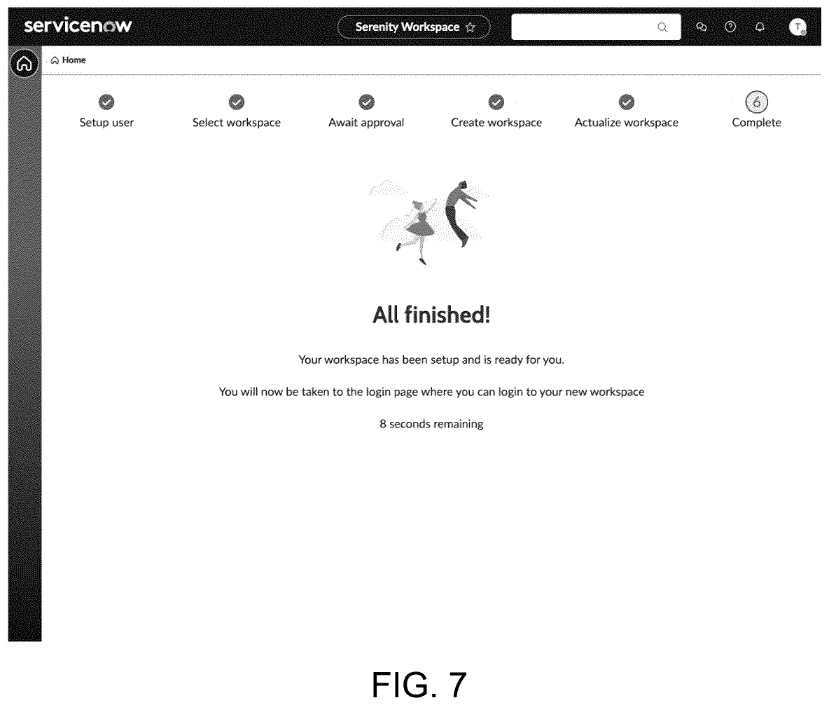

In some embodiments, creating a new protectorate can include various initialization processes, including (but not limited to) creating a new domain, initializing a set of one or more users, configuring settings for the protectorate, initializing a set of one or more applications for use within the protectorate, creating records (e.g., for users, groups, organizations, companies, establishments, locations, etc.) for the protectorate, and/or establishing security roles. In certain embodiments, the onboarding record can be updated as each stage of the creation of the protectorate is completed. In a variety of embodiments, user records can be created in an onboarding domain during the provisioning process and moved to the new protectorate once it is completed. Once the new protectorate has been created, a completion screen may be presented to the user to let them know that the process has completed. An example of a completion screen in accordance with an embodiment of the invention is illustrated in FIG. 7.

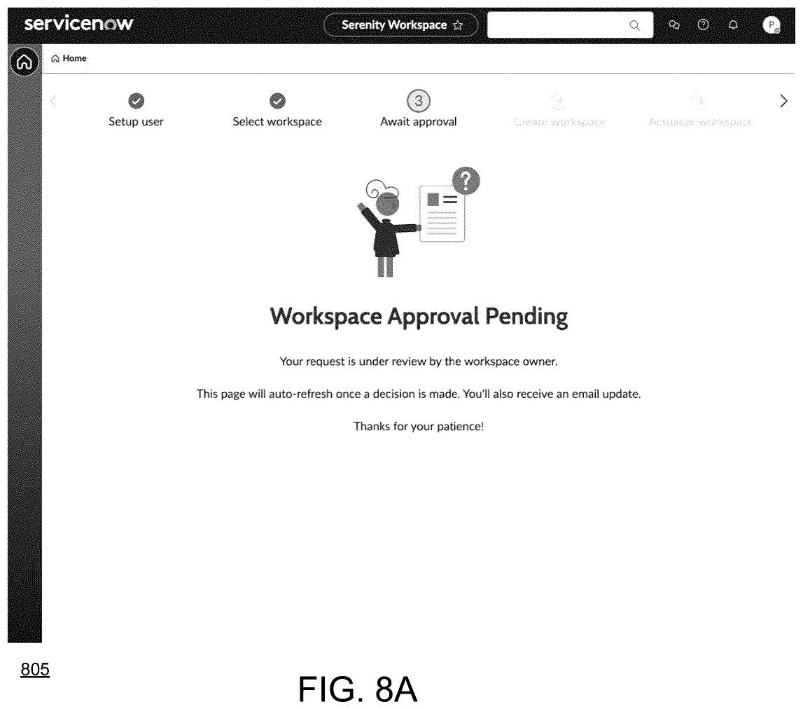

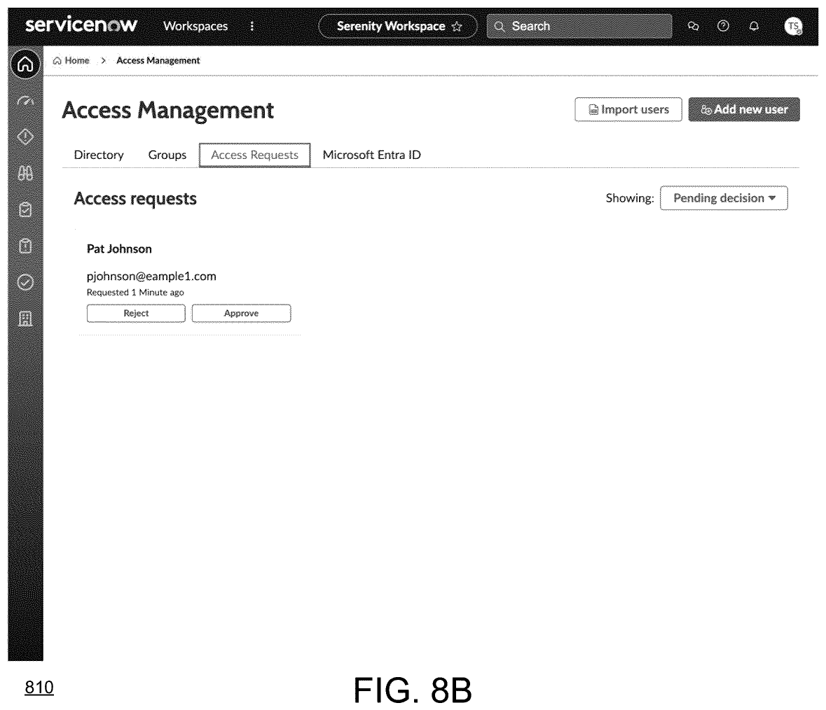

When a user chooses to join an existing protectorate, multi-protectorate systems in accordance with a number of embodiments of the invention may request access from a user (e.g., the creator and/or an admin) associated with the existing protectorate. An example of a UI for joining an existing protectorate in accordance with an embodiment of the invention is illustrated in FIGS. 8A-8B. In this example, the first view 805 illustrates that a requesting user may be informed that the request is pending. The second view 810 illustrates that an approving user (e.g., the creator and/or administrator) is presented with information about a user (e.g., name, email address, etc.) along with an option to either accept or reject the request. When a user is approved to join a protectorate, multi-protectorate systems in accordance with numerous embodiments of the invention move the user's record from an onboarding domain to the new protectorate domain.

As can readily be appreciated, the specific user interfaces used to provision multi-protectorate architectures is largely dependent upon the requirements of a given application and should not be considered as limited to any specific computing system(s) implementation.

### 2. Process

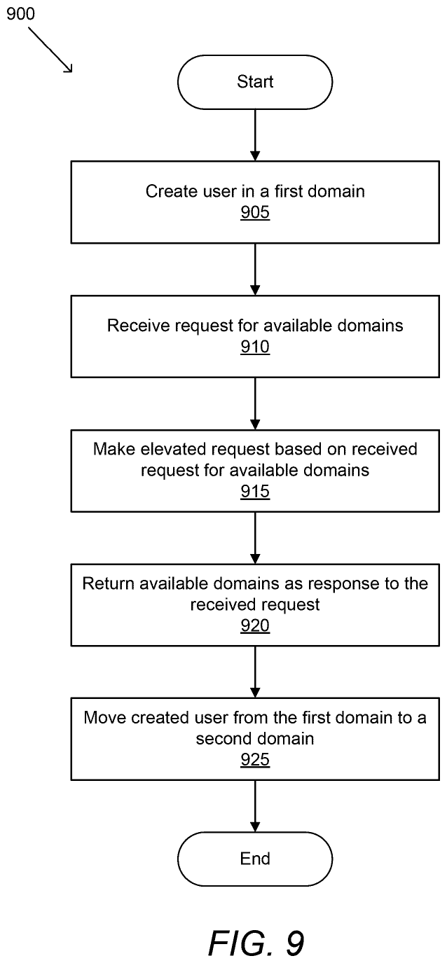

An example of a process for provisioning in accordance with an embodiment of the invention is illustrated in FIG. 9. Process 900 creates (905) a user in a first domain. In many embodiments, the first domain is an onboarding domain (or a default domain) in which all new users are created. Onboarding domains in accordance with a number of embodiments of the invention may have limited access (e.g., access to a registration page, but not to other data associated with other protectorates (or domains)). In many embodiments, user records in the first domain may be assigned a role (e.g., registration_user role) designating the user as a registration user.

Process 900 receives (910) a request associated with the created user for available domains. In numerous embodiments, the request is received from the created user in the first domain. In order to identify available domains (or protectorates) that a user may join, it may be necessary to query the protectorates to identify information (e.g., access settings, associated domains, etc.) about the domains to determine whether a domain is available for a give request. Due to security settings in a multi-protectorate environment, users in onboarding domains may not be able to make such queries across protectorates as logic executed in onboarding domains may not access data in the domain of other protectorates.

Rather than processing a request associated with the created user, processes in accordance with a variety of embodiments of the invention make a secondary request based on the request from the created user. Process 900 requests (915) available domains based on the received request. In numerous embodiments, requests for available domains made by the system are elevated requests. Elevated requests in accordance with a number of embodiments of the invention execute with elevated permissions that allow the request to be made across multiple protectorates. In many embodiments, elevated requests are made via calls (e.g., to REST API endpoints) that execute server-side logic. Processes in accordance with a number of embodiments of the invention may trigger flow designer subflows that operate as a system user (and/or within a global domain) with elevated permissions to bypass domain restrictions. Flow designer subflows can be reusable sets of actions that can be called from another flow or subflow in a multi-protectorate system. In many embodiments, elevated requests are made within a higher-level domain (e.g., a global domain) that has access to protectorates in a multi-protectorate system.

Processes in accordance with many embodiments of the invention may request available domains based on the received request. For example, processes in accordance with some embodiments of the invention request domains based on user information associated with the created user, such as (but not limited to) email addresses, company names, website URLs, etc. In numerous embodiments, processes requests available domains based at least in part on a domain associated with the created user (e.g., from email) and protectorates associated with existing users who share the same domain.

In a variety of embodiments, elevated requests can be made to request various types of domain information from the protectorates, such as (but not limited to) protectorate users, domain names, domain settings, etc. Domain settings in accordance with several embodiments of the invention may include self-registration preferences for how new users may interface with a domain. Examples of self-registration preferences in accordance with some embodiments of the invention include:
Hidden: not displayed to registering users;
Auto-join: If a new user meets certain criteria (e.g., a domain of the user's email matches a domain associated with the desired domain), the user is automatically added to the domain; and
Requestable: New users can request access to join the domain, but must be approved before being added to the domain.

Process 900 returns (920) available domains of the requested available domains as a response to the received request. Processes in accordance with a variety of embodiments of the invention may return registration options associated with the available domains (e.g., whether they can be auto-joined, require approval, etc.). In various embodiments, created users may then begin other processes to select one of the available domains, to request addition to a domain, and/or to create a new domain.

Process 900 moves (925) the created user to a second domain. In various embodiments, second domains can be one of the requested available domains (e.g., one selected by the new user, one for which permission has been granted by a user in the protectorate, etc.). In a number of embodiments, processes may perform additional steps to determine whether a user may be added to the domain. For example, in certain embodiments, processes request (e.g., by creating an approval record assigned to an owner of the domain (or workspace), which can be approved or rejected) that a user be added to a domain, and does not add the new user (e.g., by leaving them in the onboarding domain) until the request is approved. In many embodiments, second domains may include new domains created by the new user (e.g., when a new company is onboarded in a multi-protectorate system), where the created user may be added to the new domain once it has been created.

While specific processes for provisioning users in a multi-protectorate system are described above, any of a variety of processes can be utilized to provision users as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

### B. Monitoring and Load Balancing

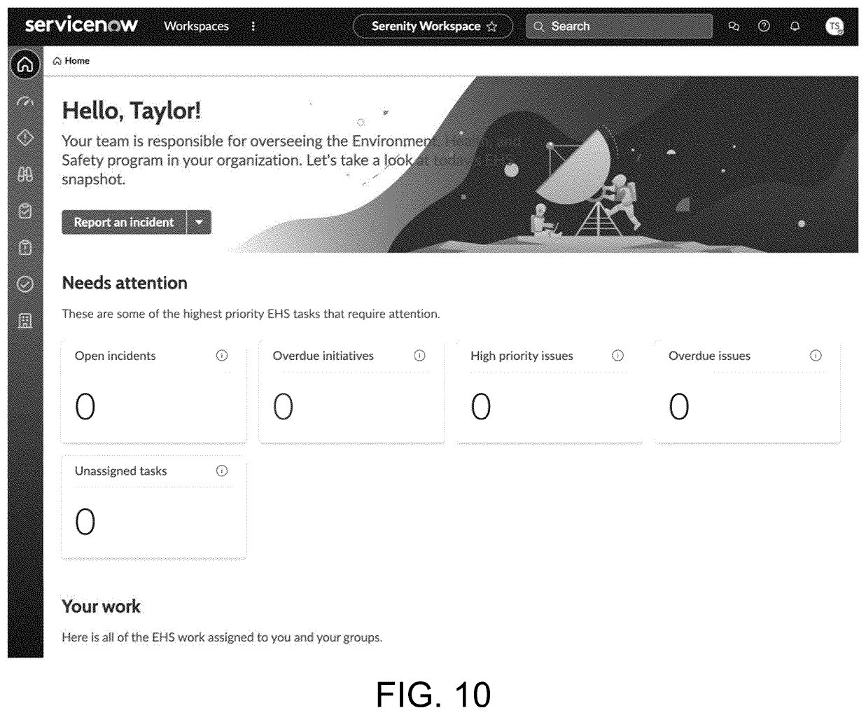

Once a protectorate has been provisioned within an instance of a cloud service, it can be utilized to access the cloud service (e.g., to run application(s)), providing the benefits of a multi-tenant architecture on an underlying multi-instance architecture. Users within a given protectorate are then unable to see data from any other protectorate, even if they operate within a single instance. An example of a workspace in accordance with an embodiment of the invention is illustrated in FIG. 10.

Although many of the examples described herein are described with relation to the SERVICENOW platform, one skilled in the art will recognize that similar systems and methods can be used in a variety of applications without departing from this invention. Accordingly, the requirements of a given application and should not be considered as limited to any specific function or service provided by the multi-instance architecture.

In some embodiments, multi-protectorate systems allow for certain users of a protectorate to modify the protectorate without affecting other protectorates. Multi-protectorate systems in accordance with some embodiments of the invention can provide a user interface for administrative users to configure the protectorate in various ways, such as (but not limited to) configuring application parameters within a protectorate, managing entitlements (e.g., adding new modules, managing license subscriptions, etc.), etc.

Administrative users within a protectorate are not system administrators and are unable to directly modify settings of the underlying instance or of any other domain. In some cases, settings to modify a protectorate (e.g., to set up single sign-on (SSO)) may not be available to an administrator within the protectorate. In several embodiments, administrative users within a protectorate can utilize an application within the protectorate to make controlled changes to the protectorate that they may not be able to make directly. Applications in accordance with many embodiments of the invention may have elevated rights and stricter controls on the modifications that an administrator of a protectorate may make.

In several embodiments, protectorates can be monitored to collect information regarding the operations of each protectorate, such as (but not limited to) performance, usage, etc. Monitoring protectorates in accordance with some embodiments of the invention can be used to optimize performance, compute costs, troubleshoot, load balance, etc.

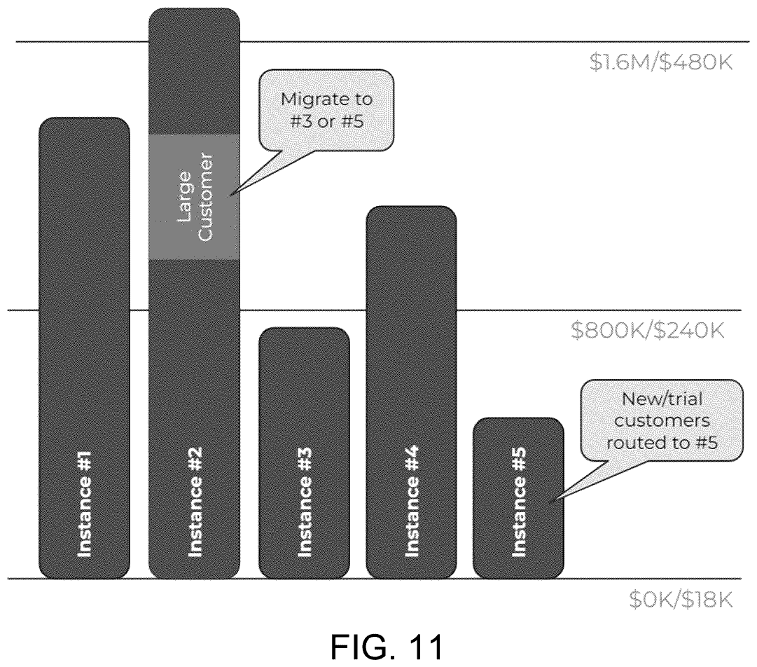

In numerous embodiments, monitored data can be used to load balance by moving protectorates between instances. An example of load balancing in accordance with an embodiment of the invention is illustrated in FIG. 11. In this example, a customer is moved from Instance #2 to Instance #3 based on a set of one or more metrics (e.g., revenue, daily average users (DAU), transactions, employees, etc.) and/or characteristics (e.g., jurisdiction, geographic region, customer type, etc.) of the instance and/or customer. In several embodiments, metrics may include an upper and lower bound. For example, protectorates may be moved away from an instance that exceeds an upper bound and moved to an instance that is below the lower bound. In some cases, lower bounds may be used to determine that an instance is no longer needed and protectorates on the instance may be moved to other instances in the system. Load balancing in accordance with a number of embodiments of the invention can allow for efficient use of the infrastructure with low risks of overloading any given instance. In certain embodiments, load balancing may also include determining an instance on which to create new protectorates based on metrics and/or characteristics of the company and/or user. For example, multi-protectorate systems in accordance with several embodiments of the invention may assign new (or trial) protectorates to an instance specifically designated for such protectorates.

As protectorates are moved (or migrated) between instances, it can be useful (or necessary) to maintain uniqueness for data as it moves across instances. While some data is universally unique, data in many systems may only be unique within an instance and may need to be managed when moved across instances. For example, sys_ids (database keys), record numbers, and certain fields on some record types (e.g., usernames) may be unique within an instance, but may not actually be unique across multiple instances. In some cases, such as sys_ids, the duplication is not a problem because they are related to system files that are shared across instances. However, other fields may need to be migrated in a way to ensure that they are unique. Multi-protectorate systems in accordance with certain embodiments of the invention can use various methods for maintaining uniqueness, including (but not limited to) primary/secondary instances, pooling, and/or prefixing.

Multi-protectorate systems in accordance with many embodiments of the invention may maintain uniqueness across instances during a migration using a primary instance to coordinate the use of pools and/or prefixes. In various embodiments, a primary instance may be identified to manage other instances of the system. In numerous embodiments, different instances can be selected to be primary instances in different situations and/or for different purposes.

Primary instances in accordance with many embodiments of the invention create number pools and assign them to other secondary instances so that different instances do not use numbers from the same pool. Secondary instances in accordance with some embodiments of the invention can request additional pools as needed. For example, a primary instance may assign a first pool of record numbers (e.g., INC00001-INC09999) to a first instance and a second, non-overlapping pool (e.g., INC10001-INC19999) to a second instance.

In certain embodiments, primary instances may utilize different prefixes for different instances to avoid duplication across instances. For example, a primary instance may assign a first prefix (e.g., INCA) to a first instance and a second prefix (e.g., INCB) to a second instance. Then each secondary instance may create records without overlap, as long as the records begin with their assigned prefix.

Once a protectorate is no longer needed, multi-protectorate systems in accordance with a number of embodiments of the invention can archive and/or dispose of protectorates. Archived protectorates may be deactivated, but data associated with the protectorate may be retained (e.g., for a period of time, due to regulatory requirements, due to some expectation that they may return as a customer, etc.). In a number of embodiments, archived protectorates may be restored to an instance, restoring access to the protectorate to its users. Protectorates (either after being archived, or directly) may be disposed (or removed) completely from a multi-protectorate system in accordance with many embodiments of the invention.

While specific implementations of monitoring and load balancing multi-protectorate systems have been described above, there are numerous configurations of load balancing, including, but not limited to, those using other known load balancing methods, and/or any other configuration as appropriate to the requirements of a given application.

### C. Systems for Multi-Protectorate Architectures

### 3. Multi-Protectorate System

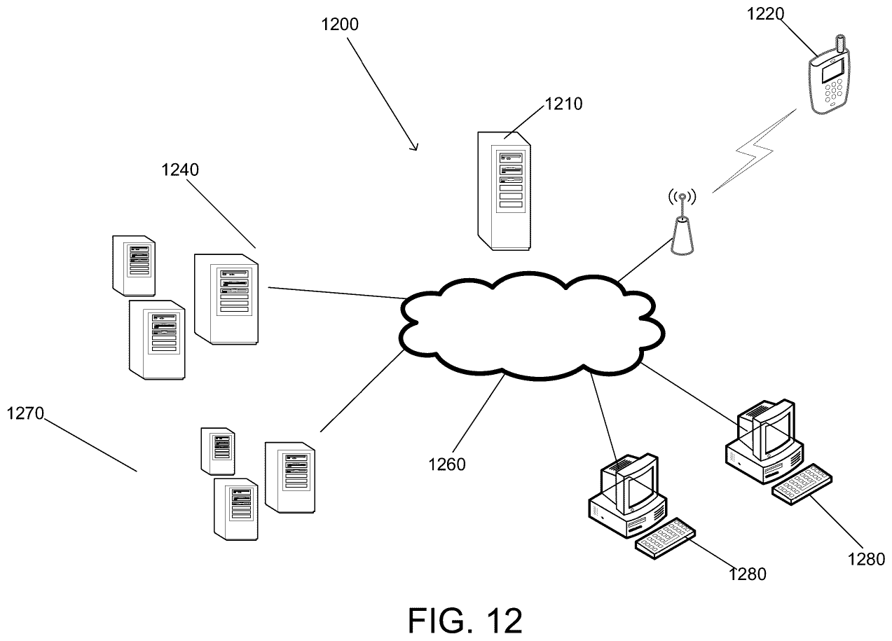

An example of a multi-protectorate system that provides multi-protectorate architectures in accordance with an embodiment of the invention is illustrated in FIG. 12. Network 1200 includes a communications network 1260. The communications network 1260 is a network such as the Internet that allows devices connected to the network 1260 to communicate with other connected devices. Server systems 1210, 1240, and 1270 are connected to the network 1260. Each of the server systems 1210, 1240, and 1270 is a group of one or more servers communicatively connected to one another via internal networks that execute processes that provide cloud services to users over the network 1260. One skilled in the art will recognize that a multi-protectorate system may exclude certain components and/or include other components that are omitted for brevity without departing from this invention.

For purposes of this discussion, cloud services are one or more applications that are executed by one or more server systems to provide data and/or executable applications to devices over a network. The server systems 1210, 1240, and 1270 are shown each having three servers in the internal network. However, the server systems 1210, 1240 and 1270 may include any number of servers and any additional number of server systems may be connected to the network 1260 to provide cloud services. In accordance with various embodiments of this invention, a multi-protectorate system that uses systems and methods for multi-protectorate architectures in accordance with an embodiment of the invention may be provided by a process being executed on a single server system and/or a group of server systems communicating over network 1260.

Users may use personal devices 1280 and 1220 that connect to the network 1260 to perform processes for multi-protectorate architectures in accordance with various embodiments of the invention. In the shown embodiment, the personal devices 1280 are shown as desktop computers that are connected via a conventional “wired” connection to the network 1260. However, the personal device 1280 may be a desktop computer, a laptop computer, a smart television, an entertainment gaming console, or any other device that connects to the network 1260 via a “wired” connection. The mobile device 1220 connects to network 1260 using a wireless connection. A wireless connection is a connection that uses Radio Frequency (RF) signals, Infrared signals, or any other form of wireless signaling to connect to the network 1260. In the example of this figure, the mobile device 1220 is a mobile telephone. However, mobile device 1220 may be a mobile phone, Personal Digital Assistant (PDA), a tablet, a smartphone, or any other type of device that connects to network 1260 via wireless connection without departing from this invention.

As can readily be appreciated the specific computing system used to provide multi-protectorate architectures is largely dependent upon the requirements of a given application and should not be considered as limited to any specific computing system(s) implementation.

### 4. Multi-Protectorate Element

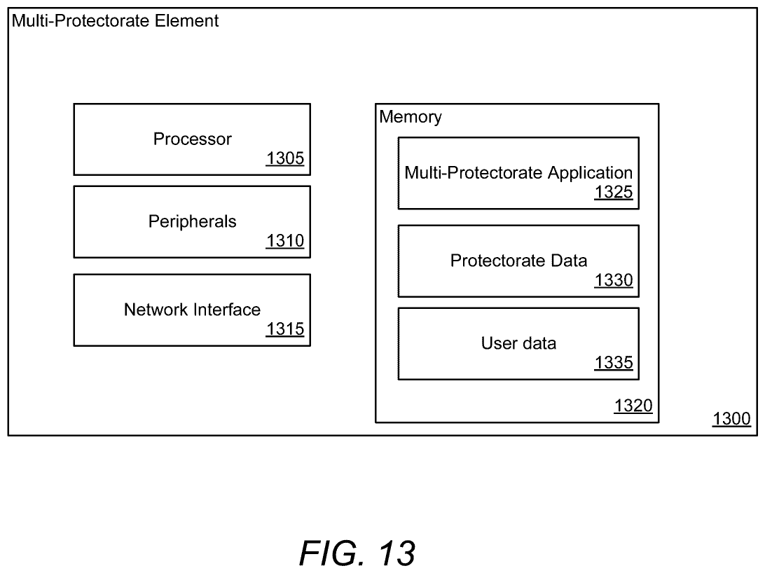

An example of a multi-protectorate element that executes instructions to perform processes that create, manage, and/or otherwise interact with multi-protectorate architectures in accordance with an embodiment of the invention is illustrated in FIG. 13. Multi-protectorate elements in accordance with many embodiments of the invention can include (but are not limited to) one or more of mobile devices, cameras, and/or computers. Multi-protectorate element 1300 includes processor 1305, peripherals 1310, network interface 1315, and memory 1320. One skilled in the art will recognize that a multi-protectorate element may exclude certain components and/or include other components that are omitted for brevity without departing from this invention.

The processor 1305 can include (but is not limited to) a processor, microprocessor, controller, or a combination of processors, microprocessor, and/or controllers that performs instructions stored in the memory 1320 to manipulate data stored in the memory. Processor instructions can configure the processor 1305 to perform processes in accordance with certain embodiments of the invention. In various embodiments, processor instructions can be stored on a non-transitory machine readable medium.

Peripherals 1310 can include any of a variety of components for capturing data, such as (but not limited to) cameras, displays, and/or sensors. In a variety of embodiments, peripherals can be used to gather inputs and/or provide outputs. Multi-protectorate element 1300 can utilize network interface 1315 to transmit and receive data over a network based upon the instructions performed by processor 1305. Peripherals and/or network interfaces in accordance with many embodiments of the invention can be used to gather inputs that can be used for multi-protectorate architectures (e.g., creation, administration, onboarding, and/or other interactions).

Memory 1320 includes a multi-protectorate application 1325, protectorate data 1330, and user data 1335. Multi-protectorate applications in accordance with several embodiments of the invention can be used with multi-protectorate architectures.

Protectorate data in accordance with a number of embodiments of the invention includes various types of data related to each protectorate, such as (but not limited to) organization data, location data, transaction data, security data, etc. User data in accordance with some embodiments of the invention includes various types of data related to each user, such as (but not limited to) security data, usernames, authentication data, role data, etc.

Although a specific example of a multi-protectorate element 1300 is illustrated in this figure, any of a variety of multi-protectorate elements can be utilized to perform processes for multi-protectorate architectures similar to those described herein as appropriate to the requirements of specific applications in accordance with embodiments of the invention.

Although specific methods of creating multi-protectorate architectures are discussed above, many different methods of creating multi-protectorate architectures can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for provisioning users in a multi-protectorate architecture on an instanced architecture, the method comprising:
creating a user in a first domain;
receiving a request for available domains, wherein each domain is associated with a protectorate of the multi-protectorate architecture;
making an elevated request based on the received request for available domains;
returning requested available domains as a response to the received request for available domains; and
moving created user from the first domain to a second domain.

2. The method of claim 1, wherein the request is received from the first user in the first domain.

3. The method of claim 1, wherein making an elevated request comprises making a call to an API endpoint for a global domain, wherein the global domain has access to a plurality of domains and the first domain does not have access to the plurality of domains.

4. The method of claim 1, wherein:
each of a plurality of domains is associated with a company;
the created user is associated with a company; and
the requested available domains include at least one domain associated with the company.

5. The method of claim 4, wherein the created user is automatically moved from the first domain to the domain associated with the company.

6. The method of claim 1, wherein:
each of a plurality of domains is associated with a set of existing users;
the created user is associated with at least one user of the set of existing users; and
at least one of the requested available domains is identified based on the at least one associated user.

7. The method of claim 1, wherein the second domain is one of the returned available domains.

8. A method for creating multi-protectorate architectures on an instanced architecture, the method comprising:
receiving a request to provision a new protectorate;
communicating with an instanced architecture to create the new protectorate;
monitoring information about a plurality of protectorates operating on a set of one or more instances of the instanced architecture; and
moving a protectorate from a first instance to a second instance based on the monitored information.

9. The method of claim 8, wherein:
the request to provision a new protectorate is from a user;
the method further comprising:
generating a user record for the user; and
generating an onboarding record for the new protectorate.

10. The method of claim 9, wherein the user record is created in an onboarding domain and creating the new protectorate comprises:
creating a new domain;
creating a set of records in the new domain; and
moving the user record for the user from the onboarding domain to the new domain.

11. The method of claim 10 further comprising updating the onboarding record when the domain is created.

12. The method of claim 8, wherein monitoring information comprises monitoring at least one selected from the group consisting of revenue, daily average users (DAU), number of transactions, and number of employees.

13. The method of claim 8, wherein moving the protectorate comprises:
providing a pool of record numbers from a primary protectorate; and
using the pool of record numbers to create new records for the protectorate.

14. The method of claim 8, wherein moving a protectorate comprises providing a prefix unique to each instance of a multi-instance architecture to each of a plurality of protectorates, wherein each protectorate of the plurality of protectorates utilizes the prefix for data within the protectorate.
